(19) United States
(12) Patent Application Publication
(10) Pub. No.: US 2019/0070665 A1
(43) Pub. Date: Mar. 7, 2019

(54) METHOD FOR MANUFACTURING A TITANIUM ALUMINIDE COMPONENT WITH A DUCTILE CORE AND CORRESPONDINGLY MANUFACTURED COMPONENT

(71) Applicant: MTU Aero Engines AG, Muenchen (DE)

(72) Inventors: Martin SCHLOFFER, Muenchen (DE); Wilfried SMARSLY, Muenchen (DE)

(21) Appl. No.: 16/112,797

(22) Filed: Aug. 27, 2018

(30) Foreign Application Priority Data
Sep. 1, 2017 (DE) 102017215321.0

(51) Int. Cl. B22F 5/04; B33Y 10/00; B33Y 70/00; B22F 3/15; B22F 3/24; B23K 26/342; F01D 5/14

(52) U.S. Cl. CPC B22F 5/04; B33Y 10/00; B33Y 70/00; B33Y 80/00; B22F 3/24; B23K 26/342; F01D 5/147; B22F 3/15

(57) ABSTRACT

A method is provided, for manufacturing a component of a turbomachine, in particular a blade, in which initially a shell (6) including an interior cavity (7) corresponding to the outer contour of the component is manufactured from an intermetallic TiAl material, and subsequently a Ti alloy in powder form is filled into the cavity, and the cavity with the filled-in Ti alloy powder is tightly sealed, the tightly sealed shell (6) including the enclosed titanium alloy powder being subsequently processed into a component of the turbomachine using hot isostatic pressing. Alternatively, the invention relates to a method for generatively manufacturing a component including a shell made from a TiAl alloy and a core made from a Ti alloy. In addition, the invention relates to a correspondingly manufactured component.

This claims the benefit of German Patent Application DE 102017215321.0, filed Sep. 1, 2017, and hereby incorporated by reference herein.

The present invention relates to a method for manufacturing a component of a turbomachine, in particular a blade of a gas turbine or an aircraft engine, and also a correspondingly manufactured component and in particular a blade of a turbomachine.

### BACKGROUND

Turbomachines, such as stationary gas turbines or aircraft engines, have been known and used for a long time. However, there remains the desire and the need to increase the effectiveness and efficiency of such machines. For this purpose, it has been attempted to manufacture certain components of the turbomachine, for example moving blades, from lightweight materials. By reducing the weight of the moving blades, both the total weight of the turbomachine may be reduced, which is of particular interest for aircraft engines, and also the effectiveness may be positively influenced by reducing the mass to be moved. In addition, it has also been attempted to improve the effectiveness of turbomachines by increasing the operating temperatures.

Correspondingly, it is already known from the prior art to use intermetallic materials, such as titanium aluminides, for the manufacture of moving blades for turbomachines, as these are characterized by a high temperature strength and a low specific weight, so that the use of these materials promises high efficiency increases.

### SUMMARY OF THE INVENTION

However, the use of titanium aluminide materials, in particular for aircraft engines, yields the problem that the fracture toughness is low due to the intermetallic properties of the material, and correspondingly manufactured components are susceptible to impact loads. The problem thus exists for aircraft engines, that, in the case of foreign objects ending up in the engine, there is a risk that blades manufactured from titanium aluminide materials will be damaged when foreign objects impact on the blades.

It is an object of the present invention to provide a design and a method for manufacturing components from titanium aluminide materials for turbomachines and corresponding components, which have a higher robustness with respect to impact stress. At the same time, the corresponding manufacturing method should be able to be easily carried out and the corresponding components should facilitate a consistent effectiveness of the turbomachine in comparison to known TiAl components.

The present invention provides a method for manufacturing a component of a turbomachine, and a component of a turbomachine.

The present invention provides that a corresponding component of a turbomachine, which is manufactured at least partially from titanium aluminides, is configured in such a way that the component has a shell made from an intermetallic TiAl alloy, while the core, which is surrounded by the shell, is formed by a titanium alloy with a higher ductility than that of the intermetallic TiAl alloy. Thus, the different properties of the two different materials, namely the titanium aluminides and the titanium alloys, may be combined with one another. The titanium aluminides and the titanium alloys may be combined with one another. The titanium aluminide material of the component shell provides the component with a high strength at a low specific weight and, in particular, high-temperature strength and a sufficiently high-temperature resistance, in particular oxidation resistance, while the core made from a titanium alloy provides the component with the necessary ductility. Namely, if an impact stress of the component occurs, for example, due to the effect of a foreign object which has entered into the turbomachine, or due to an object which originates in an upstream stage of the turbomachine, then, in the case of a failure of the intermetallic titanium aluminide shell, the core made from a titanium alloy may maintain the structural stability so that an abrupt total failure may be prevented. The slight additional weight due to the titanium alloy, which has a higher specific weight than the intermetallic titanium aluminide materials, may be accepted to achieve a higher operational reliability.

Intermetallic titanium aluminide materials or TiAl alloys are understood within the scope of the present invention to be materials which include titanium and aluminum as main components and include intermetallic phases, like Ti₃Al, γ—TiAl and the like in the structure. In addition to the main components, titanium and aluminum, in which both the titanium and the aluminum may be present in the largest proportion in the corresponding material, different alloy components may be present in the titanium aluminide materials, for example, niobium, molybdenum, etc. Examples of possible titanium aluminide materials are TNM™ with 43.5 at. % aluminum (Al), 4 at. % niobium (Nb), 1 at. % molybdenum (Mo), and 0.1 at. % boron (B), and residual titanium (Ti) and unavoidable impurities, or GE 4822 with 48 at. % aluminum (Al), 2 at. % niobium (Nb), 2 at. % chromium (Cr), and residual titanium (Ti) and unavoidable impurities, whereby the indicated compositions relate to the conventional nominal compositions, from which there may be deviations within the specification.

Titanium alloys are understood to be alloys whose main component is titanium. In particular, high-temperature titanium alloys may be used, for example Ti6242 with 6 at. % aluminum (Al), 2 at. % tin (Sn), 4 at. % zirconium (Zr), 2 at. % molybdenum (Mo), and residual titanium (Ti) and unavoidable impurities, Timetal 1100 with 6 at. % aluminum (Al), 2.7 at. % tin (Sn), 4 at. % zirconium (Zr), 0.4 at. % molybdenum (Mo), 0.45 at. % silicon (Si), up to 0.03 at. % iron (Fe), and residual titanium (Ti) and unavoidable impurities, Ti64 with 6 at. % aluminum (Al), 4 at. % vanadium (V), and residual titanium (Ti) and unavoidable impurities, or IMI834 with 5.5 at. % aluminum (Al), 4 at. % tin (Sn), 3.5 at. % zirconium (Zr), 0.7 at. % niobium (Nb), 0.5 at. % molybdenum (Mo), 0.35 at. % silicon (Si), and residual titanium (Ti) and unavoidable impurities, whereby the indicated compositions relate to the conventional nominal compositions, from which there may be deviations within the specification.

A corresponding component of a turbomachine, for example a blade, may be manufactured according to the present invention in that initially a shell is manufactured from an intermetallic titanium aluminide material, the shell having an outer contour which may already largely correspond to the outer contour of the component to be manufactured. As will be described below, the dimensions of the initially manufactured shell may be somewhat larger than the dimensions of the finished component, and/or the component may be subsequently machined at the outer contour to a certain extent.

The shell made from an intermetallic titanium aluminide material has an interior cavity into which a titanium alloy in powdered form (titanium alloy powder) may be filled after the manufacturing of the shell in order to thus form the core of the component. Correspondingly, the cavity of the shell has a shape which corresponds to the core of the component, which is surrounded by the shell after finishing the component, and which is formed from a titanium alloy.

After filling the titanium alloy powder into the cavity of the shell, the cavity is tightly sealed using the filled-in titanium alloy powder, whereby this may be carried out under vacuum conditions, so that gas still present in the cavity may be evacuated before the cavity is sealed.

The tightly sealed shell with the enclosed titanium alloy powder is processed using hot isostatic pressing into the desired component of the turbomachine. By using the hot isostatic pressing, the titanium alloy powder enclosed in the cavity may be consolidated and processed into a solid body.

To prevent coarse grain growth of the titanium alloys during the hot isostatic pressing, the titanium alloy powder may include a proportion of higher-melting foreign particles, such as oxides, carbides, silicides, or also intermetallic particles, in particular intermetallic TiAl particles, which do not melt during the hot isostatic pressing and thus pin down the grain boundaries of the titanium alloy powder of the titanium alloy.

The proportion of foreign particles or TiAl particles in the titanium alloy powder may lie in the range of 2 through 20 vol. %, in particular in the range of 8 through 15 vol. %.

The titanium alloy powder may be additionally configured in such a way that the proportion of fine powder particles, which have grain sizes of less than 15 μm, is less than or equal to 5 vol. %, in particular is less than or equal to 1 vol. %.

The shell may be manufactured using generative or additive methods in which the shell is built up in layers, for example, made from powder material. In particular, the shell may be manufactured using laser beam melting, in particular selective laser beam melting, or electron beam melting. The generative methods have the advantage that virtually any shapes of the shell may be manufactured with any surface structures and undercuts.

Correspondingly, the interface between core and shell may have a three-dimensional surface structure so that core and shell intermesh with one another due to the shape of the interface. In addition, a three-dimensional inner contour of the shell, in which the interface between the core and shell does not lie in one plane or a smooth surface, but instead has directional changes with depressions and projections, may yield additional reinforcement or increase the strength, in particular with respect to bending stresses.

The shell may also be configured in such a way that, for example for a blade for a turbomachine, the root area of the blade is completely configured as an integral part of the shell, so that a core made from a titanium alloy is only present in the vane area.

Sealing the cavity after filling in the titanium alloy powder may be carried out similarly to the generative manufacturing of the shell likewise using a high energy beam, with which the top layer of the filled-in titanium alloy powder may be fused so that the corresponding opening of the cavity is sealed following renewed solidification of the melt.

The hot isostatically pressed component may be subjected to a heat treatment following the hot isostatic pressing in order to adjust the structure of the core and/or the shell in a suitable way.

As already mentioned above, individual or multiple or even all steps of the method may be carried out under vacuum conditions. In particular, the generative manufacturing of the shell and the filling of the titanium alloy powder into the cavity of the shell and also the sealing of the cavity following the filling in of the titanium alloy powder using a high-energy beam may be carried out under high vacuum, in order to prevent environmental influences on the structural formation of the component to be manufactured.

After the hot isostatic pressing, the component may be subjected to a finishing operation for exact dimensioning of the manufactured component and/or for setting a desired surface finish. For example, the surface may be mechanically or electrochemically finished.

Alternatively to forming a shell for the Ti alloy powder and hot isostatic pressing of the component, both the shell made from a TiAl alloy and the core made from a Ti alloy may be formed using generative methods, such as laser beam melting or electron beam melting, in particular selective laser beam melting, or selective electron beam melting.

### BRIEF DESCRIPTION OF THE FIGURES

The appended drawings show purely schematically in:

FIG. 1 a longitudinal section through a semi-finished blade according to the present invention,

FIG. 2 a sectional view along cutting line A-A from FIG. 1,

FIG. 3 a sectional view along cutting line B-B from FIG. 1

FIG. 4 a sectional view along cutting line C-C from FIG. 1, and

FIG. 5 a longitudinal section through another specific embodiment of a semi-finished blade according to the present invention.

### DETAILED DESCRIPTION

Additional advantages, characteristics, and features of the present invention are apparent in the subsequent detailed description of the exemplary embodiments. However, the present invention is not limited to these exemplary embodiments.

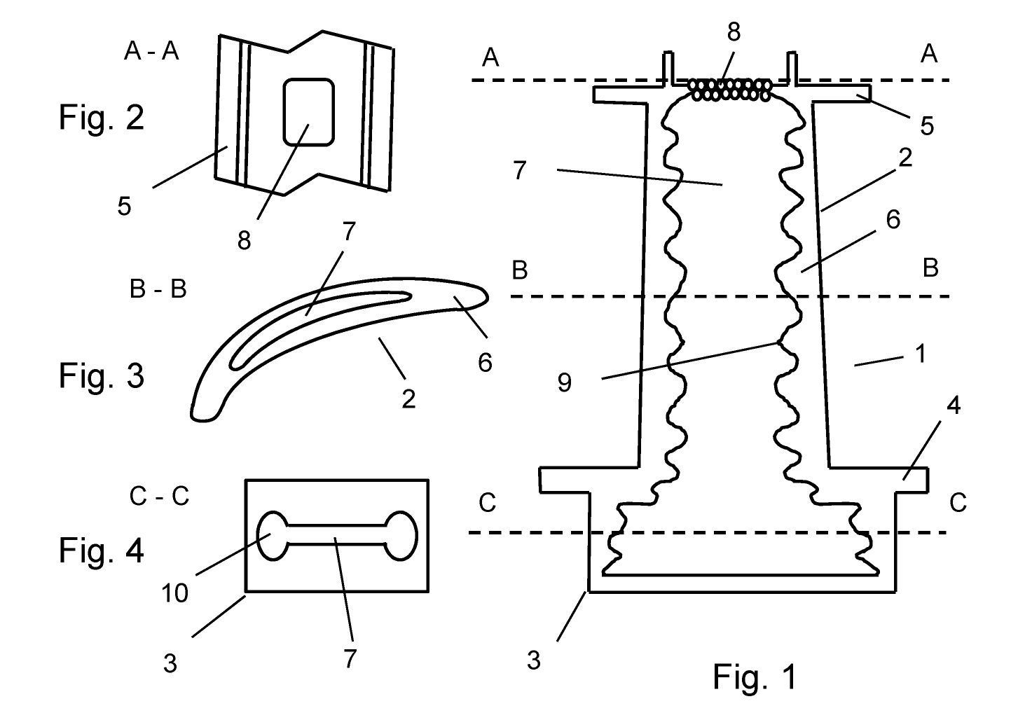

FIG. 1 shows a longitudinal section through a semi-finished blade of a turbomachine, for example of a gas turbine or an aircraft engine, as is used for the manufacturing of a corresponding blade according to the present invention.

Blade 1 includes a vane 2 and a blade root 3. An inner shroud 4 is arranged between blade root 3 and vane 2, whereas an outer shroud 5 is provided at the blade tip. Blade 1 is formed according to the present invention with an outer shell 6 which surrounds an inner core. In the semi-finished part shown in FIG. 1, a cavity 7 is formed which corresponds to the subsequent core of the blade.

In FIG. 1, shell 6 of blade 1 is apparent, which has been manufactured from a TiAl powder using a generative method. Laser beam melting or electron beam melting may be used as the generative method. Cavity 7, apparent inside of shell 6, may also be designated as powder channel 7, as the powder for the core of blade 1 is situated in cavity 7. Correspondingly, in a finished blade 1, the area of cavity 7 is filled by the core of blade 1. To fill in the powder for the core, an opening 8 is provided on the upper side of cavity 7 or powder channel 7, into which the powder may be filled to form the core of blade 1. In the depiction of FIG. 1, opening 8 is schematically sealed by a plurality of welded layers, which are generated by fusing the top layers of the powder in powder channel 7 and subsequently solidifying the melt in order to seal opening 8 airtight. The powder in the cavity or the powder channel is not shown for reasons of simplicity.

As is likewise apparent from FIG. 1, cavity 7 has a three-dimensional inner contour 9 with a plurality of depressions and projections, so that the core created from the powder filled into powder channel 7 is intermeshed with shell 6 by inner contour 9. This effectuates not only a good connection between the core and shell 6, but also an increase in the strength of shell due to inner contour 9.

FIGS. 2 through 4 show different sectional views along cutting lines A-A, B-B, and C-C. It is likewise apparent in the sectional views of FIGS. 2 through 4 how powder channel 7 or the subsequent core of blade 1 is formed.

In FIG. 2, which shows a sectional view in the area of upper shroud 5, opening 8 is apparent, via which the powder for the core of blade 1 may be filled into powder channel 7. Opening 8 is sealed after filling powder channel 7 by fusing the top powder layers.

FIG. 3 shows a cross section in the area of vane 2, surrounding shell 6 made from a titanium aluminide material and being clearly apparent, surrounds core 7 made from a high-temperature resistant titanium alloy.

A cross section through root 3 of blade 1 is shown in FIG. 4, powder channel 7 and thus the subsequent core of blade 1 having a powder channel expansion 10 or an expansion of the core at each of the ends, so that a higher proportion of the ductile titanium alloy is present at the end faces of the root, so that the ductility of blade root 3 is increased in the case of an impact in these areas.

Overall, it arises from FIGS. 1 through 4 that the cavity or powder channel 7 and correspondingly the core thus formed, which is surrounded by titanium aluminide shell 6, may be formed in different ways in order to achieve the desired and suitable strength of titanium aluminide shell 6 and the required ductility of the core.

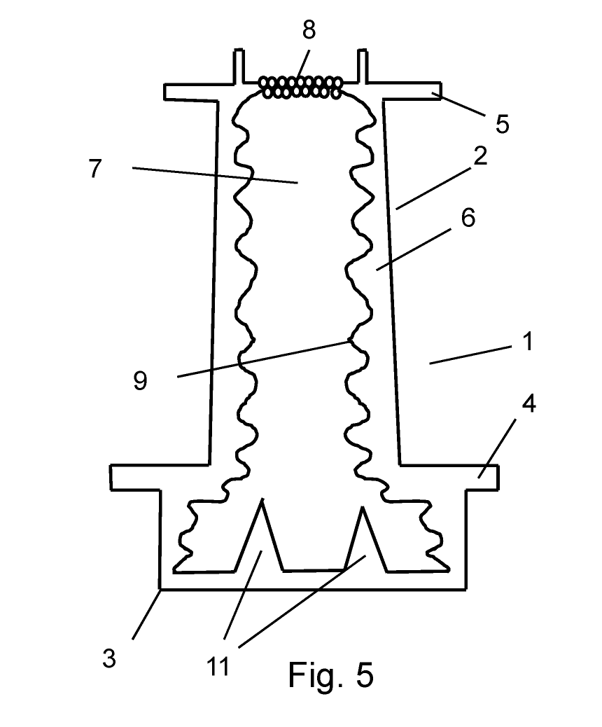

FIG. 5 shows another example of a semi-finished blade 1, in which influence may be exerted on the property profile of blade 1 with respect to strength and ductility due to the configuration of shell 6 and cavity 7, in that, for example, titanium aluminide shell 6 is formed with reinforcements 11.

The method according to the present invention may now be carried out in such a way that initially shell 6 is formed from a titanium aluminide material, whereby a generative or additive method may be preferably used, in which powder material is fused in layers, so that, after the solidification of each melt, a solid semi-finished product is created corresponding to the material solidified in layers. In particular, arbitrary shapes may be implemented by generative methods, so that inner contour 9 of shell 6 may be advantageously configured in an arbitrary way.

After manufacturing shell 6, a powder material is filled into cavity 7 via opening 8, and subsequently opening 8 is tightly sealed, preferably by fusing the top powder layers of the filled-in powder. The sealing of opening 8 may, for example, be carried out similarly to the generative manufacturing of shell 6 by fusing with a high-energy beam, preferably an electron beam or a laser beam.

In the present invention, the filled-in powder material includes a titanium alloy, which has a higher ductility or a lower elastic modulus than the titanium aluminide material of shell 6. For example, the elastic modulus of the shell may lie in the range of 160 GPa, whereas the elastic modulus of the titanium alloy may lie in the range of 120 GPa.

In addition, a certain amount of titanium aluminide powder may be present in the powder material, which is filled into cavity 7 to form the core of blade 1, this titanium aluminide powder preventing grain growth during the subsequent heat treatment, during which the titanium alloy is present in the β phase field, and pinning down the grain boundaries of the titanium alloy.

After filling the powder material into cavity 7 and sealing cavity 7 by fusing the powder material at opening 8, the semi-finished product thus generated is hot isostatically pressed and subjected to a suitable heat treatment. Thus, both the structure of the titanium aluminide material of shell 6 and the structure of the titanium alloy of the core of blade 1 may be set in the desired way. The shrinkage of the semi-finished product during the hot isostatic pressing may be taken into consideration beforehand by a larger dimensioning of shell 6.

Following the hot isostatic pressing and the heat treatment, the component or blade 1 thus generated may be finished, in that, for example, the surface receives a corresponding surface finish through a mechanical and/or electrochemical finishing, and the seal of opening 8 is mechanically or electrochemically subsequently machined.

Even though the present invention has been described in detail based on the exemplary embodiments, it is obvious for those skilled in the art that the present invention is not limited to these exemplary embodiments, but instead many variations are possible, in that individual features may be omitted or different combinations of features may be employed without departing from the scope of protection of the appended claims. In particular, the present invention includes all combinations of the individual features shown in the different exemplary embodiments, so that individual features, which are only described in connection with one exemplary embodiment may also be used with other exemplary embodiments, or combinations of individual features, which are not explicitly depicted, may also be used.

### LIST OF REFERENCE NUMERALS

1 Blade
2 Vane
3 Blade root
4 Inner shroud
5 Outer shroud
6 Shell
7 Powder channel or core
8 Opening or seal
9 Inner contour
10 Powder channel or core expansions
11 Shell reinforcements

What is claimed is:

1. A method for manufacturing a component of a turbomachine, comprising the steps of:
initially manufacturing a shell including an interior cavity corresponding to an outer contour of the component from an intermetallic TiAl material;
subsequently filling a Ti alloy in powder form into the cavity;
sealing the cavity with the filled-in Ti alloy powder to define a tightly sealed shell with enclosed Ti alloy powder; and
subsequently processing the tightly sealed shell with the enclosed Ti alloy powder into the component of the turbomachine using hot isostatic pressing.

2. The method as recited in claim 1 wherein the component is a blade.

3. The method as recited in claim 1 wherein the Ti alloy powder contains a proportion of high-melting point foreign particles.

4. The method as recited in claim 3 wherein the high-melting point foreign particles are TiAl particles.

5. The method as recited in claim 3 wherein the proportion of high-melting point foreign particles in the Ti alloy powder lies in the range of 2 through 10 vol. %.

6. The method as recited in claim 5 wherein the proportion of high-melting point foreign particles in the Ti alloy powder lies in the range of 8 through 15 vol. %.

7. The method as recited in claim 1 wherein a proportion of fine powder particles with grain sizes smaller than 15 μm in the Ti alloy powder is less than or equal to 5 vol. %.

8. The method as recited in claim 7 wherein the proportion of fine powder particles with grain sizes smaller than 15 μm in the Ti alloy powder is less than or equal to 1 vol. %.

9. The method as recited in claim 1 wherein the shell is manufactured using a generative method building up the shell in layers.

10. The method as recited in claim 9 wherein the generative method is laser beam melting or electron beam melting.

11. The method as recited in claim 10 wherein the generative method is selective laser beam melting.

12. The method as recited in claim 1 wherein the cavity including the filled-in Ti alloy powder is sealed by fusing the filled-in Ti alloy powder.

13. The method as recited in claim 12 wherein the fusing is by electron beam or laser beam melting.

14. The method as recited in claim 1 wherein the hot isostatically pressed component is subjected to a heat treatment.

15. The method as recited in claim 1 wherein at least one of the steps of the method is carried out under vacuum conditions.

16. The method as recited in claim 1 wherein the hot isostatically pressed component is subjected to a finishing operation for exact dimensioning or surface setting.

17. A component of a turbomachine the component, the component comprising a shell made from an intermetallic TiAl-alloy, the shell surrounding a core formed from a Ti alloy with a higher ductility than the intermetallic TiAl alloy of the shell.

18. A component of a turbomachine the component manufacturing according to the method of claim 1, the component comprising a shell made from an intermetallic TiAl-alloy, the shell surrounding a core formed from a Ti alloy with a higher ductility than the intermetallic TiAl alloy of the shell.

19. The component as recited in claim 17 wherein the component is a blade.

20. The component as recited in claim 17 wherein the core has a structure with intermetallic TiAl particles embedded between crystalline particles of the Ti alloy.

21. The component as recited in claim 17 wherein an interface between the core and the shell has a three-dimensional surface structure.

22. The component as recited in claim 17 wherein the component is a blade, only a vane area having a core made from a Ti alloy surrounded by a TiAl shell, whereas a root area of the blade and the shell are constructed completely from a TiAl-alloy.

23. A method for manufacturing a component of a turbomachine, the method comprising the steps of:
manufacturing a shell with an outer contour of the component manufactured in layers from an intermetallic TiAl material using a generative manufacturing method, and
manufacturing a core, surrounded by the shell, from a Ti alloy in powder form.

24. The method as recited in claim 23 wherein the component is a blade.

25. The method as recited in claim 24 wherein the Ti alloy powder contains a proportion of high-melting point foreign particles.

26. The method as recited in claim 25 wherein the high-melting point foreign particles are TiAl particles.

27. The method as recited in claim 25 wherein the proportion of high-melting point foreign particles in the Ti alloy powder lies in the range of 2 through 10 vol. %.

28. The method as recited in claim 27 wherein the proportion of high-melting point foreign particles in the Ti alloy powder lies in the range of 8 through 15 vol. %.

29. The method as recited in claim 23 wherein a proportion of fine powder particles with grain sizes smaller than 15 μm in the Ti alloy powder is less than or equal to 5 vol. %.

30. The method as recited in claim 29 wherein the proportion of fine powder particles with grain sizes smaller than 15 μm in the Ti alloy powder is less than or equal to 1 vol. %.

31. The method as recited in claim 23 wherein the shell is manufactured using a generative method building up the shell in layers.

32. The method as recited in claim 31 wherein the generative method is laser beam melting or electron beam melting.

33. The method as recited in claim 32 wherein the generative method is selective laser beam melting.

34. The method as recited in claim 23 wherein the cavity including the filled-in Ti alloy powder is sealed by fusing the filled-in Ti alloy powder.

35. The method as recited in claim 34 wherein the fusing is by electron beam or laser beam melting.

36. The method as recited in claim 23 wherein the shell is subjected to a heat treatment.

37. The method as recited in claim 23 wherein at least one of the steps of the method is carried out under vacuum conditions.

38. The method as recited in claim 23 wherein the shell is subjected to a finishing operation for exact dimensioning or surface setting.

39. A component of a turbomachine the component manufacturing according to the method of claim 23, the component comprising a shell made from an intermetallic TiAl-alloy, the shell surrounding a core formed from a Ti alloy with a higher ductility than the intermetallic TiAl alloy of the shell.

40. The component as recited in claim 39 wherein the core has a structure with intermetallic TiAl particles embedded between crystalline particles of the Ti alloy.

41. The component as recited in claim 39 wherein an interface between the core and the shell has a three-dimensional surface structure.

42. The component as recited in claim 39 wherein the component is a blade, only a vane area having a core made from a Ti alloy surrounded by a TiAl shell, whereas a root area of the blade and the shell are constructed completely from a TiAl-alloy.
